(19) United States
(12) Patent Application Publication
(10) Pub. No.: US 2024/0210299 A1
(43) Pub. Date: Jun. 27, 2024

(54) Method and Classification System for Single Cell Analysis

(71) Applicant: TDK Corporation, Tokyo (JP)

(72) Inventor: Rakesh Sethi, San Jose, CA (US)

(73) Assignee: TDK Corporation, Tokyo (JP)

(21) Appl. No.: 18/529,856

(22) Filed: Dec. 5, 2023

Related U.S. Application Data
(60) Provisional application No. 63/432,777, filed on Dec. 15, 2022.

(51) Int. Cl. G01N 15/12

(52) U.S. Cl. CPC G01N 15/132; G01N 2015/1006

(57) ABSTRACT

A system and method for generating a signal map are disclosed. The system includes memory, one or more processors, instructions stored in the memory and configured for execution by the one or more processors. The system generates a signal profile for each block of a plurality of blocks obtained from a tissue sample, where each block of the plurality of blocks contains multiple cells. The system generates a spatial map of signals from a plurality of signal profiles corresponding to the plurality of blocks. In some embodiments, the system further creates a tree of cell populations from the spatial map. In some embodiments, the system includes a microfluidic device (e.g., a microfluidic sensor chip) configured to detect impedance of cells, and the signal profile for each block is an impedance profile generated based on impedances detected from the microfluidic device.

This application claims the benefit of U.S. Provisional Patent Application No. 63/432,777 filed Dec. 15, 2022, which is incorporated by reference herein in its entirety.

This application is related to U.S. patent Ser. No. 17/970,569 (U.S. Application Publication No. 20230241605) filed Oct. 21, 2022, which is a continuation-in-part application of U.S. patent Ser. No. 17/589,591 (U.S. Application Publication No. 20230241610) filed Jan. 31, 2022, each of which is incorporated by reference herein in its entirety.

This application is related to PCT Application No. PCT/US2023/011676 (WO2023/146999) filed Jan. 27, 2023, claiming priority to U.S. patent Ser. No. 17/589,591 (U.S. Application Publication No. 20230241610) filed Jan. 31, 2022, and Ser. No. 17/970,569 filed Oct. 21, 2022, each of which is incorporated by reference herein in its entirety.

This application is related to PCT Application No. PCT/US2023/011677 (WO2023/147000) filed Jan. 27, 2023, claiming priority to U.S. patent Ser. No. 17/589,593 (U.S. Application Publication No. 20230241611) filed Jan. 31, 2022, each of which is incorporated by reference herein in its entirety.

### TECHNICAL FIELD

This application relates generally to microfluidic analysis, and more particularly to systems, devices, methods, and non-transitory computer-readable storage medium for analyzing cells or particles of a tissue sample using a microfluidic device, e.g., for cell analysis.

### BACKGROUND

Cell plasticity refers to the ability of cells to change their phenotypes without genetic mutations in response to changes in their environment. In some cases, plasticity in diseased cells (e.g., cancer cells) can push tumors to evolve and resist drugs.

### SUMMARY

It has been a challenge to quantify cell plasticity from various tissues of diseased cells at a single-cell level. Diseased cells exhibit phenotypic changes that are not seen in normal cells. Sub-populations of diseased cells demonstrate heterogeneity or variability that leads to finer variations in cellular morphology. These changes or variations require measurements of temporal samples of phenotypical surface and sub-surface characteristics in an extended duration of time.

In some embodiments, methods for quantifying cell plasticity are implemented using cell-labeling technologies, where cells are derived from tissue samples, encapsulated, bar-coded, tagged with labels (e.g., fluorescent dyes or magnetic labels), and sorted using fluorescence-activated cell sorting (FACS) or magnetic cell sorting. In some situations, these techniques detect some variants in diseased cells, and their associated results are not consistent and are highly dependent on sample preparation. Furthermore, in some situations, tools and techniques do not have a sufficiently high sensitivity to detect certain sub-variations in the phenotype. In an example, cell phenotype classification is based on optical methods. Certain diseased cells exhibit weak or no optical signatures, and appear as noise to cell phenotype classification, thereby leading to poor promiscuity differentiation. Furthermore, microfluidic devices are used for optical detection, and require complex single cell flowing and guiding based on microscopy and visual detection, which easily limits a flow or throughput of a tissue sample. An optical signal of the microfluidic devices is also a weak measure of signaling entropy because of an inability to separate cellular subtypes.

Accordingly, there is a need for improved systems, methods, and devices that enable phenotype analysis of cells at the single-cell level.

Some embodiments of the present disclosure describe using a microfluidic device to measure signals (e.g., impedance or current signals) from unlabeled cells at the single cell level.

Impedance probing is a method that allows for label-free examination and classification of cells. Diseased cells exhibit different impedance fingerprints (e.g., impedance signals or phenotypical impedance signals) from those of normal cells. The impedance fingerprints differ amongst different types of diseased cells. Impedance signals are highly correlated to a signaling entropy of cells, and impedance probing is applied to classify a heterogeneous mixture of cells and identify normal and diseased cells.

As disclosed herein, a tissue sample of cells is partitioned into blocks (e.g., solid blocks). Each block contains multiple cells. The spatial information of each block is recorded. The cells of each block are disassociated from the block to form a respective liquid suspension of cells, which is then passed through a microfluidic device with a single-cell detection sensitivity. The microfluidic device includes a sensor chip for detecting signal changes (e.g., real type and complex impedance changes or current changes) as each single cell passes under the electrodes on the chip. A signal profile for the cells corresponding to each block is recorded and stored. In some embodiments, the signal profile is a time-series plot showing impedance values over time, or change in impedance values over time, or change in current values over time. In some embodiments, a respective liquid suspension of cells (corresponding to one block) is input into the microfluidic device multiple times, and the signal profiles from the multiple runs are aggregated. (e.g., summed or averaged). In some embodiments, a distribution of frequency rankings of signal amplitudes is obtained from the signal profile for each block. In some embodiments, a spatial map of signals is generated from signal profiles corresponding to the blocks of the tissue sample. In some embodiments, a tree of cell populations is created from the spatial map of signals, and used to visualize how cancer cells (and cancer cell types) are distributed across many blocks within the mass of tissue sample.

As disclosed herein, the tissue sample is partitioned into blocks that each contains multiple cells without need for labeling (i.e., without fluorescence or magnetic labels). In some embodiments, the size of the blocks is selected based on a desired signal-to-noise ratio.

As disclosed herein, the signaling entropy of the cells is determined at single-cell level based on an impedance of a single cell that is measured by an impedance sensor of the microfluidic device as the single cell passes the impedance sensor.

In accordance with some embodiments, a method of generating a signal map for a mixture of cells includes generating a signal profile for each block of a plurality of blocks obtained from a tissue sample. Each block of the plurality of blocks contains multiple cells. The method further includes generating a signal profile for each block of a plurality of blocks obtained from a tissue sample. Each block of the plurality of blocks contains multiple cells. The method further includes generating a spatial map of signals from a plurality of signal profiles corresponding to the plurality of blocks.

In accordance with some embodiments, a system includes memory and one or more processors. The memory stores a plurality of instructions and data configured for execution by the one or more processors. The plurality of instructions includes instructions for performing any of the methods disclosed herein.

In accordance with some embodiments, a non-transitory computer-readable storage medium stores one or more programs configured for execution by a computing device having one or more processors and memory. The one or more programs include instructions for performing any of the methods described herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A shows a microfluidic device for flow control of cells or particles in a microfluidic channel in accordance with some embodiments.

FIG. 1B shows a microfluidic device for flow control of cells or particles in a microfluidic channel in accordance with some embodiments.

FIG. 2 is a block diagram illustrating electrical components for flow control of cells or particles in a microfluidic channel in accordance with some embodiments.

FIG. 3 illustrates an exemplary tissue slice 302 in accordance with some embodiments.

FIG. 4 illustrates an exemplary process in which a tissue slice is divided into blocks 304 for microfluidics measurements, in accordance with some embodiments.

FIG. 5 illustrates three exemplary signal profiles, in accordance with some embodiments.

FIG. 6 illustrates a histogram of cell populations for an exemplary block of cells, in accordance with some embodiments.

FIG. 7 illustrates an example signal profile (e.g., an impedance profile) measured for a block of tissue sample in a frequency domain, in accordance with some embodiments.

FIG. 8 illustrates a spatial map (e.g., a spatial map of signals), in accordance with some embodiments.

FIG. 9A illustrates a tree of cell populations in three-dimensional perspective, in accordance with some embodiments. FIG. 9B illustrates a two-dimensional projection of the tree in FIG. 9A, in accordance with some embodiments.

FIG. 10 is a block diagram of a system configured to perform single cell phenotype analysis, in accordance with some embodiments.

FIGS. 11A and 11B illustrate a flowchart diagram for a method of generating signal maps, in accordance with some embodiments.

### DESCRIPTION OF EMBODIMENTS

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

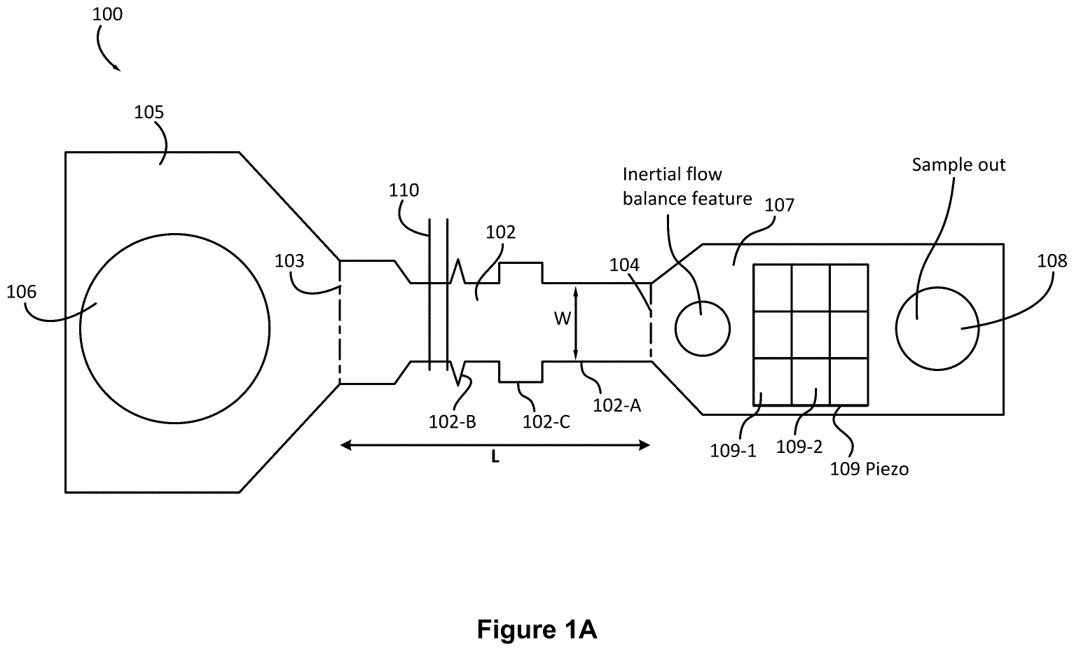

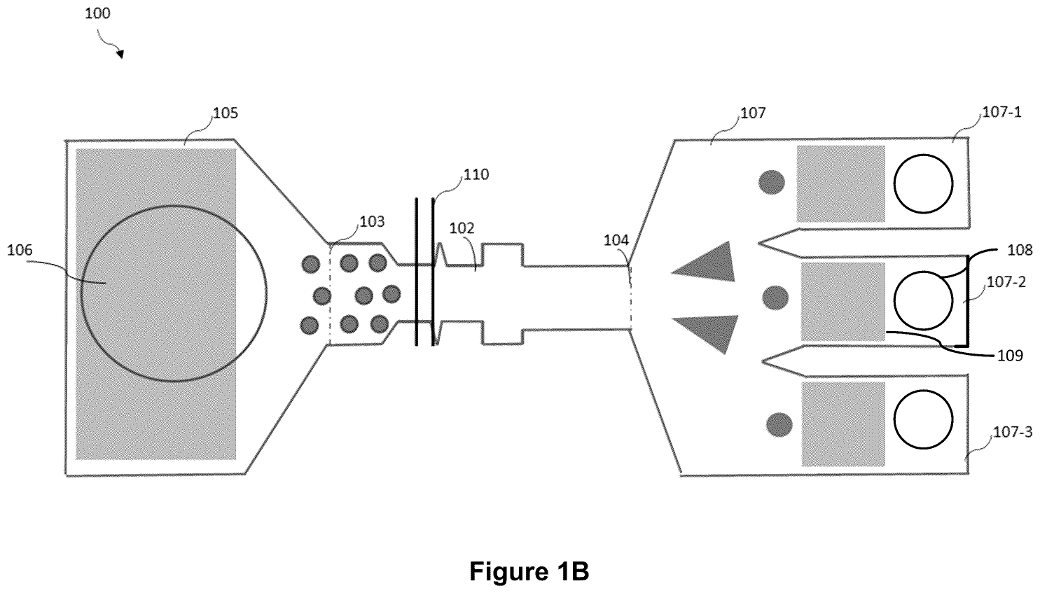

FIG. 1A shows a microfluidic device 100 in accordance with some embodiments. The device 100 includes a fluid channel 102 (e.g., a microfluidic channel) formed on a substrate. In some embodiments, the fluid channel 102 may be formed by coupling a first substrate with an indentation, recess, or notch with a second substrate so that the fluid channel 102 is defined between the first substrate and the second substrate.

The fluid channel 102 has an inlet 103 and an outlet 104, both of which are illustrated by dashed lines in FIG. 1A. The locations of the inlet 103 and the outlet 104 shown with respect to the fluid channel 102 in FIG. 1A, are mere examples. The inlet 103 and the outlet 104 may be defined at any other location along the length dimension of the fluid channel 102 or the device 100. In some embodiments, the length of the fluid channel 102, L (e.g., measured from the inlet 103 to the outlet 104), is in the range of 1 mm to 50 mm. In some embodiments, a width W (e.g., a representative portion, such as 102-A, which may be the narrowest portion) of the fluid channel 102 may be configured based on the size of the particle to be analyzed. For example, for cellular measurements, the width W of the fluid channel 102 is configured in accordance with the size of the cell such that only a single cell is detected at a time. In some embodiments, the width W of the fluid channel 102 is in the range of 10 μm to 100 μm (e.g., 50 μm). In some embodiments, the fluid channel 102 includes one or more portions that have a width different from the width W. For example, as shown in FIG. 1A, the fluid channel 102 may include portions 102-B and 102-C having (protruding) shapes such that widths of the portions 102-B and 102-C are greater than the width W. Similarly, the fluid channel 102 may include one or more portions with widths narrower than the width W. In some embodiments, the wider the fluid channel 102 is, the slower is the velocity of the particles flowing in the corresponding portion of the fluid channel 102 (e.g., when the fluid channel 102 has a uniform height). As such, for example, the wider portion 102-C is used to reduce the velocity of the particles (e.g., immobilize the particles), which allows for more time for analyzing the particles.

The device 100 includes an input region 105 for receiving at an inlet port 106 a sample fluid with particles (e.g., cells) as an input to the device 100 and providing the sample fluid from the inlet port 106 to the fluid channel 102 via the inlet 103. The device 100 further includes an output region 107 for collecting at least a portion of the sample fluid from the fluid channel 102 via the outlet 104 and ejecting or delivering the sample fluid portion via an outlet port 108 (e.g., a nozzle) for further processing or analysis. In some embodiments, the diameter of the outlet port 108 is in the range of 60 microns to 120 microns. In some embodiments, the fluid channel 102 is configured such that the inlet port 106 is the inlet 103 and the outlet port 108 is the outlet 104 of the fluid channel 102.

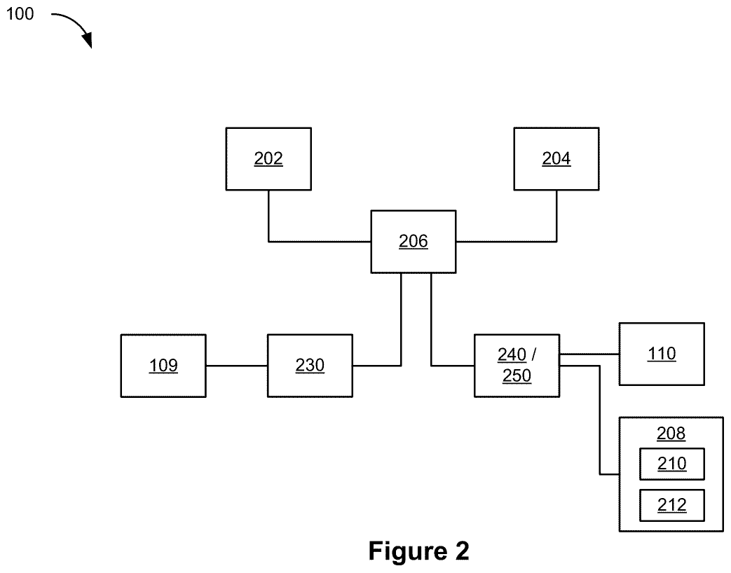

In some embodiments, the output region 107 includes a first array of piezoelectric actuators 109 located adjacent to the outlet 104 for ejecting a portion of the fluid in the fluid channel 102. In some embodiments, the first array of piezoelectric actuators 109 includes one or more piezoelectric actuators (e.g., a piezo micro-electro-mechanical system (MEMS) actuator). In some embodiments, the first array of piezoelectric actuators 109 includes two or more piezoelectric actuators (e.g., piezo actuators 109-1 and 109-2). In some embodiments, each of the first array of piezoelectric actuators 109 is a piezoelectric element. The piezoelectric element may have a length equal to 1 mm and a width equal to 0.5 mm. In some embodiments, the device 100 includes actuation circuitry (e.g., actuation circuitry 230 described with respect to FIG. 2) electrically coupled to the first array of piezoelectric actuators 109. In some embodiments, upon application of an electrical signal from the actuation circuitry, the first array of piezoelectric actuators 109 generates oscillations that create displacement as well as acoustic waves, which controls localized inertial movement of the particles in the fluid channel 102 in the three-dimensional x, y and z planes with sub-micron level control. In some embodiments, the first array of piezoelectric actuators 109 induces a laminar flow from the inlet 103 toward the outlet 104.

In some embodiments, the device 100 includes one or more pairs of electrodes 110 (e.g., a pair of electrodes). The one or more pairs of electrodes 110 may be used for charging particles flowing through the fluid channel 102 so that the particles can be manipulated with an electrical field. In some embodiments, the distance between a pair of the electrodes 110 is configured such that only a single cell is manipulated with an electrical field at a time.

In some embodiments, one or more pairs of electrodes 110 are also referred to as electromagnetic field generators. For example, in some embodiments, the one or more pairs of electrodes 110 may be configured to apply a preset frequency to the input cells. In some embodiments, the preset frequency corresponds to a particular type of cell abnormality. In some embodiments, the preset frequency is in the range of 1 kHz to 10 GHz.

In some embodiments, the device 100 includes a microfluidics sensor chip 208. In some embodiments, the device includes one or sensors 210 (e.g., that is coupled on sensor chip 208 described with respect to FIG. 2). The one or more sensors 210 are configured to detect signal changes, such as impedance or current changes (e.g., single ended or double ended differential) as a single cell passes through the fluid channel 102 (e.g., through or under the one or more pairs of electrodes 110).

In some embodiments, the device 100 is capable of measuring signal profiles (e.g., impedance profiles or current profiles) of cells with single cell sensitivity. For example, in some embodiments, the device 100 includes a transimpedance amplifier 212 (e.g., coupled to the sensor chip 208) that is capable of generating signal profiles of cells as a single cell passes through the fluid channel 102 (e.g., through or under the one or more pairs of electrodes 110). In some embodiments, generating the signal profile includes measuring one or more capacitance values for a cell (e.g., due to diseased cells having higher capacitance values than normal (non-diseased) cells, and consequently diseased cells have higher impedance values than normal cells).

In some embodiments, the device 100 is configured to measure an impedance of the input cells. In some embodiments, the device 100 is configured to measure an impedance of the input cells in response to a preset frequency (e.g., applied by the one or more pairs of electrodes 110). In some embodiments, each measurement of impedance of the input cells is performed with a different set of parameters. For example, in some embodiments, the set of parameters include an applied frequency (or a lock-in frequency), a flow rate, and a sample fluid mixture. In some embodiments, the processing time for each cell sample is in a time range of 0.5 seconds to 10 seconds.

In some embodiments, the device 100 includes driver circuitry (e.g., driver circuitry 240 described with respect to FIG. 2) electrically coupled to the one or more pairs of electrodes 110. In some embodiments, the driver circuitry is configured to produce electrical signals in the MHz and GHz frequency domains. In some embodiments, the frequency of the electrical signals provided to the one or more pairs of electrodes 110 depends on a type or types of the particles to be analyzed using the device 100.

In some embodiments, the output region 107 is divided into a plurality of output sub-regions (e.g., sub-regions 107-1 through 107-3) as shown in FIG. 1B. In some embodiments, each output sub-region having an outlet port and at least one of the first array of piezoelectric actuators 109. In this embodiment, each of different portions (e.g., each portion corresponding to a particular cell or a type of cell) of the sample fluid from the outlet 104 is deflected toward a corresponding output sub-region of the output region 107. As such, each of the different portions of the sample fluid is collected at and ejected from the corresponding output sub-region. The deflection of the different portions of the sample fluid may be achieved, for example, by the oscillations and displacement caused by the activation of the first array of piezoelectric actuators 109 (and/or other piezoelectric actuators implemented in or operationally associated with the device 100).

FIG. 2 is a block diagram illustrating electrical components for flow control of particles in a fluid channel in accordance with some embodiments. In some embodiments, the device 100 includes one or more processors 202 and memory 204. In some embodiments, the device 100 includes a microfluidics sensors chip 208. The device includes one or more sensors 210 (e.g., coupled to the sensor chip 208) that is configured to detect impedance or current changes as a single cell passes through a fluid channel 102. In some embodiments, the device 100 includes a transimpedance amplifier 212 configured to generate a signal profile for cells. In some embodiments, the memory 204 includes instructions for execution by the one or more processors 202. In some embodiments, the stored instructions include instructions for providing actuation signals to the first array of piezoelectric actuators 109 (and/or other arrays of actuators). In some embodiments, the actuation signals for the arrays of piezoelectric actuators may be configured such that each array of piezoelectric actuators create oscillations at a different frequency from a frequency of oscillations of another array of piezoelectric actuators. For example, in some embodiments, the first array of piezoelectric actuators 109 may operate at a frequency in the range between 0.5 kHz and 100 kHz based on desired flow rates. In some embodiments, the stored instructions include instructions for providing actuation signals to the electrodes 110 for charging particles flowing through the fluid channel 102 so that the particles can be manipulated with an electrical field.

In some embodiments, the device also includes an electrical interface 206 coupled with the one or more processors 202 and the memory 204.

In some embodiments, the device further includes actuation circuitry 230, which is coupled to one or more piezoelectric actuators, such as the first array of piezoelectric actuators 109, The actuation circuitry 230 sends electrical signals to the one or more arrays of piezoelectric actuators 109 to initiate actuation of the one or more arrays of piezoelectric actuators.

In some embodiments, the device further includes driver circuitry 240, which is coupled to one or more electrodes, such as the electrodes 110. The driver circuitry 240 sends electrical signals to the one or more electrodes 110 to generate an electrical field using the one or more electrodes for charging particles flowing through the fluid channel 102.

In some embodiments, the device further includes readout circuitry 250, which is coupled to one or more electrodes, such as the electrodes 110. The readout circuitry 250 receives electrical signals from the one or more electrodes 110 and provides the electrical signals (with or without processing) to the one or more processors 202 via the electrical interface 206. In some embodiments, the readout circuitry 250 is coupled to one or more sensors, such as the sensors 210. The readout circuitry 250 receives signals (e.g., impedance signals or current signals) from the one or more sensors 210 and provides the signals (with or without processing) to the one or more processors 202 via the electrical interface 206.

### Methods and Systems for Phenotype Analysis of Single Cells

Some embodiments of the present disclosure are directed to methods, devices, and systems for single cell phenotype analysis.

Some embodiments of the present disclosure include obtaining a three-dimensional tissue sample (e.g., from a biopsy) for phenotype analysis. In some embodiments, the tissue sample has a volume of about 5 mm³ to 1 cm³. In some embodiments, the tissue sample has a cross-sectional area of about 10 mm² to 200 mm². The tissue sample contains cells, each of the cells having a respective cell type. In some embodiments, the tissue sample contains cells belonging to multiple cell types. In some embodiments, the tissue sample contains cells that all belong to a single (i.e., the same) cell type. In some embodiments, the tissue sample includes cancer cells. In some embodiments, the tissue sample includes stem cells.

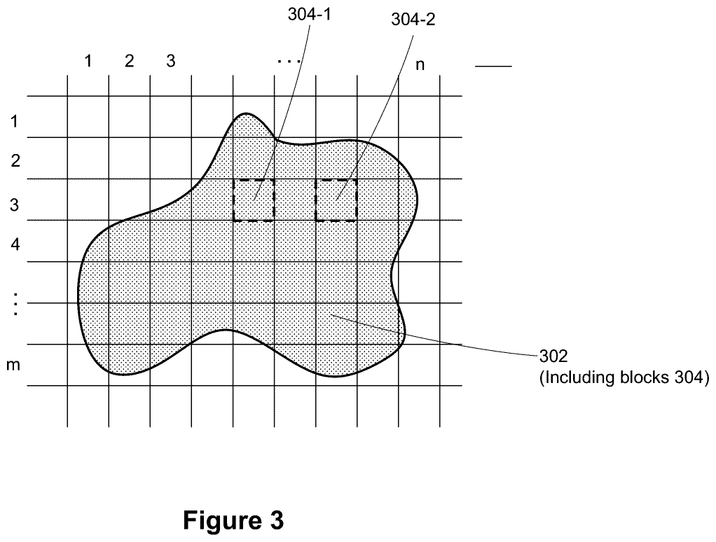

In some embodiments, the tissue sample is partitioned (e.g., cut) into tissue slices. FIG. 3 illustrates an exemplary tissue slice 302 in accordance with some embodiments. In some embodiments, a tissue slice has a thickness of about 0.2 mm to 5 mm.

In some embodiments, a tissue slice 302 (or a tissue sample) is further partitioned into multiple blocks. In the example of FIG. 3, the tissue slice 302 is partitioned into a matrix (e.g., a grid or an array) of m rows and n columns. Each unit in the matrix is identified by its respective coordinates (x,y) and is also referred to as a block 304 (e.g., a tissue block) (e.g., block 304-1 and block 304-2). For example, a tissue slice that is partitioned into a matrix of 10 rows and 10 columns has 100 blocks. In some embodiments, a respective block has a cross-sectional area of about 1-5 mm². In some embodiments, each of the blocks of a tissue slice has same size. In some embodiments, the tissue slice is partitioned into multiple blocks that have at least two distinct sizes. In some embodiments, the size of the block is selected based on a desired signal-to-noise ratio (e.g., of the signal profile to be collected).

In some embodiments, a method of single cell phenotype analysis includes collecting (e.g., generating or obtaining) a signal profile (e.g., an impedance profile or a current profile) for a respective block 304 of cells (or for each block of cells) of the tissue sample using a microfluidics device (e.g., device 100).

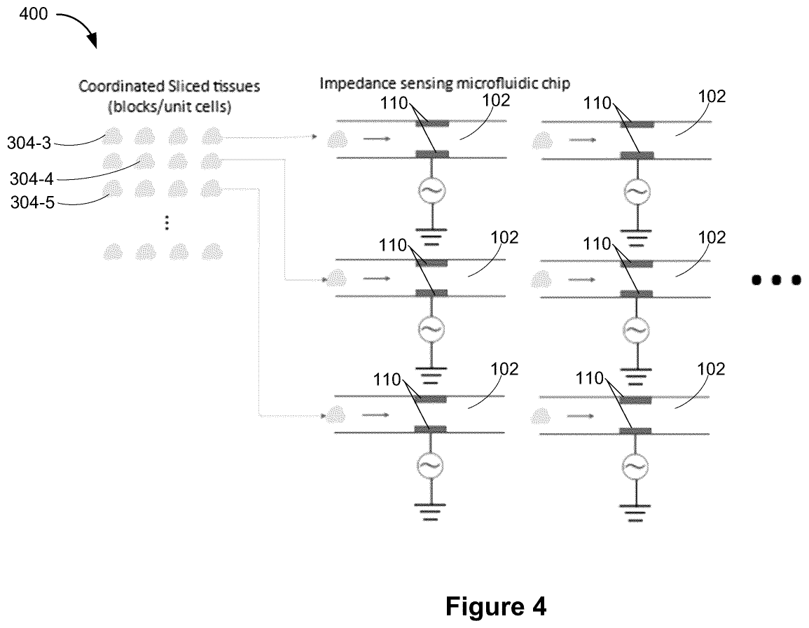

FIG. 4 illustrates an exemplary process 400 in which a tissue slice is divided into blocks 304 for microfluidics measurements, in accordance with some embodiments. In some embodiments, the spatial information of a block 304 (e.g., relative to other blocks in the same tissue slice, and/or relative to other tissue slices of the tissue sample) is recorded as the block is prepared for microfluidics measurements. Typically, the preparation process includes dissociating the block 304 into a liquid suspension of cells (e.g., by adding a buffer solution to the block and centrifuging the mixture).

For microfluidics measurements, the liquid suspension is input into a microfluidics device that includes one or more sensors (e.g., sensor 210) capable of detecting impedance or current changes (e.g., single ended or double ended differential) as each individual cell travels through a respective channel 102 (and passes through or between a respective pair of electrodes 110). In some embodiments, the electrodes 110 are capable of applying a preset frequency in the range of about 1 kHz to 10 GHz, to capture the real (resistive) and imaginary (reactance) part of the impedance signal. In some embodiments, the impedance measurements are performed with a transimpedance amplifier. Exemplary methods and systems for analyzing cellular samples using impedance spectroscopy are disclosed in U.S. patent application Ser. No. 17/488,374, titled “Apparatus, methods and computer programs for analysing cellular samples,” which is incorporated by reference herein in its entirety.

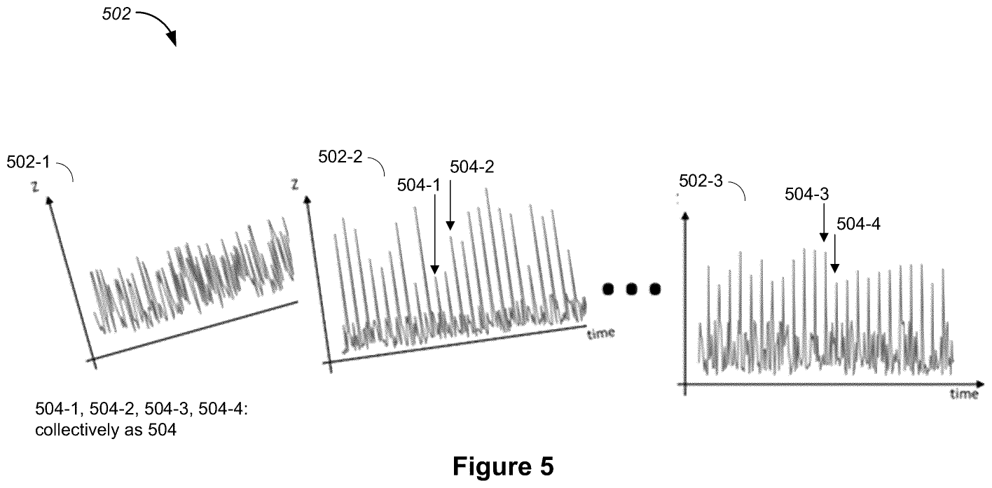

FIG. 5 illustrates three exemplary signal profiles 502 (e.g., time-series plots), in accordance with some embodiments. In some embodiments, a respective signal profile 502 is a profile of noise from the system (e.g., microfluidic device 100). In some embodiments, a respective signal profile 502 corresponds to a respective block 304 of cells. For example, in FIG. 5, signal profile 502-1 corresponds to an example system noise that can later be removed by digital signal processing. Signal profile 502-2 corresponds to block 304-4 (FIG. 4), and signal profile 502-3 corresponds to block 304-5 (FIG. 4). Each of the data points 504 in the signal profiles 502-2 and 502-3 (e.g., data points 504-1 and 504-2 in signal profile 502-2; and data points 504-3 and 504-4 in signal profile 502-3) corresponds to a measurement of a single cell. In some embodiments, a signal profile comprises an impedance profile, which is a time-series plot of impedance values (in the vertical axis) over time (in the horizontal axis). In some embodiments, a signal profile comprises a current profile, which is a time-series plot of current values (in the vertical axis) over time (in the horizontal axis).

In some embodiments, the signal profiles 502 are stored on the device 100, or on a computer system that is communicatively connected to the device 100.

In some embodiments, the microfluidics device 100 is configured to obtain signals of the same block of cells multiple times (e.g., by repeating measurements for the same block of cells or by subjecting the same block to multiple runs on the microfluidic device 100). In some embodiments, the time taken for each run is about 0.5 seconds to 10 seconds.

In some embodiments, the microfluidics device 100 is configured to obtain signals of known cell lines, to establish baseline or “ground truth” measurements of these cell lines.

In some embodiments, the microfluidics device 100 is configured to obtain signals of just the buffer solution (i.e., without any cells) in which a respective block of cells is suspended, to establish the “noise floor” of the device.

In some embodiments, each cell type has a respective predefined signal value (e.g., impedance or current value) within a margin of error (e.g., ±0.1%, ±0.5%, ±1.0%, or ±2.0%). Thus, in some embodiments, the signal values (corresponding to data marks 504) of a signal profile 502 are further analyzed to identify and/or quantify cell populations for a respective block 304 of cells.

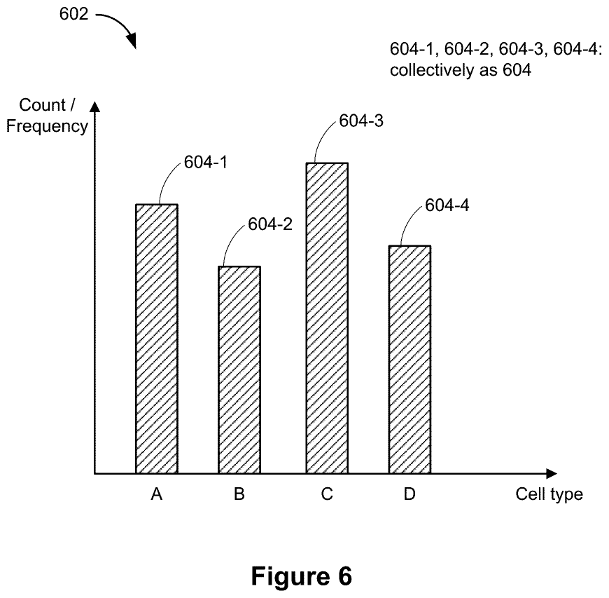

FIG. 6 illustrates a histogram 602 of cell populations for an exemplary block 304 of cells, in accordance with some embodiments. In the example of FIG. 6, each bar 604 (e.g., bar 604-1, 604-2, 604-3, and 604-4) corresponds to a cell type (e.g., cell type A, B, C, or D) that is present in the block. The height of the bar represents the respective count (e.g., frequency) of cells corresponding to the cell type. For example, FIG. 6 shows that most of the cells in the exemplary block are Type C cells, followed by Type A cells, Type D cells, and Type B cells.

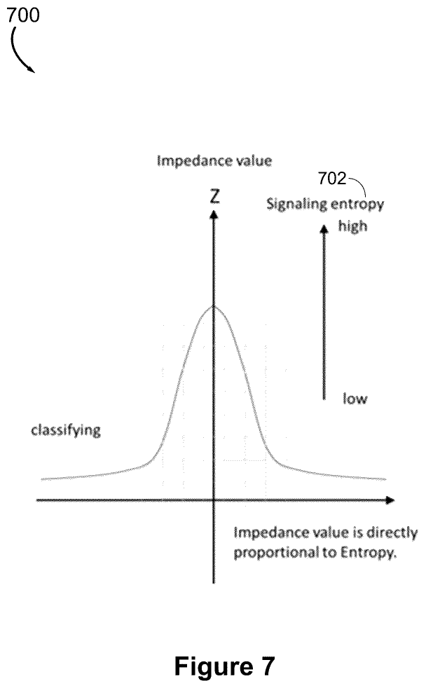

FIG. 7 illustrates an example signal profile 700 (e.g., impedance profile) measured for a block 304 of tissue sample in a frequency domain, in accordance with some embodiments. In some embodiments, the signal profile 700 represents a profile of an impedance value measured for the block 304 of tissue sample. In some embodiments, a signaling entropy is proportional to the impedance value measured for the block 304 of tissue sample, and the signal profile 700 represents a profile of the signal entropy 702.

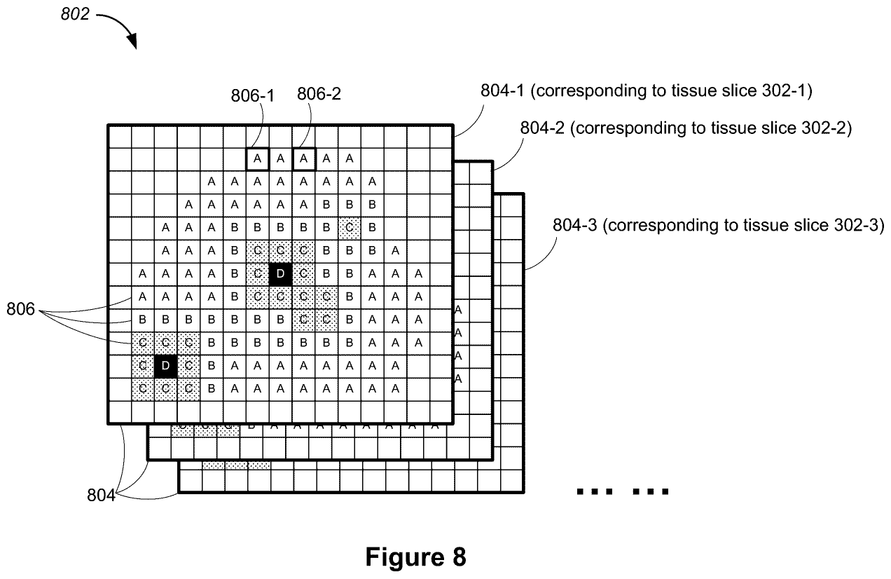

FIG. 8 illustrates a spatial map 802 (e.g., a spatial map of signals), in accordance with some embodiments. In some embodiments, the signal profiles 502 of the blocks 304 (FIG. 5) and the spatial information of the blocks is used to generate spatial map 802 that depicts how cells are distributed across the tissue sample. Referring to FIG. 8, in some embodiments, the spatial map 802 includes map slices 804 (e.g., map slices 804-1 to 804-3). Each map slice 804 is composed of units 806 (e.g., unit 806-1 and unit 806-2). In some embodiments, each map slice 804 corresponds to a respective tissue slice 302. In some embodiments, a respective unit 806 in a map slice 804 corresponds to a respective block 304 of the tissue slice 302. In some embodiments, a unit 806 is encoded (e.g., color coded or text-coded) with information regarding cell populations (e.g., cell types and their corresponding counts) that are present in the corresponding block 304. In some embodiments, the spatial map provides a visualization of how the cells are distributed across many blocks within the three-dimensional mass of tissue.

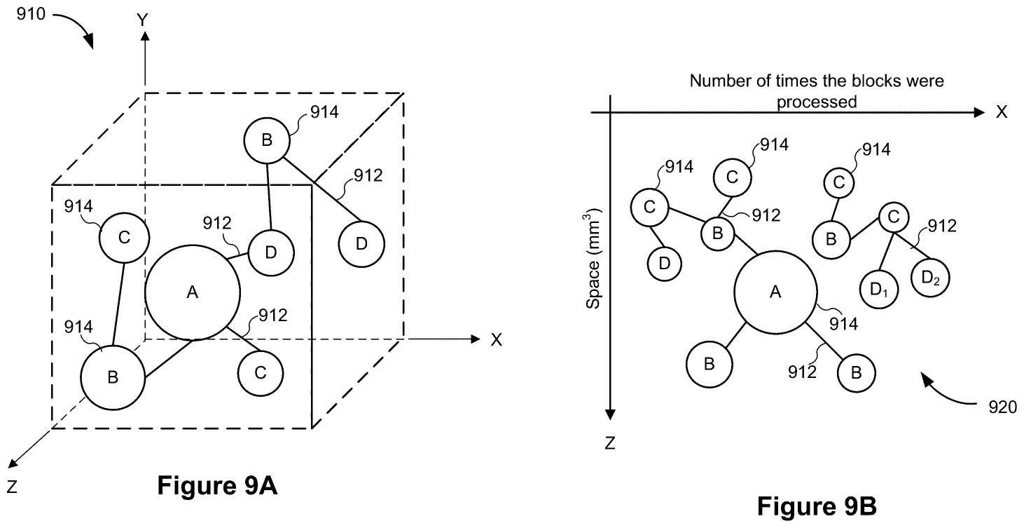

FIG. 9A illustrates a tree 910 of cell populations in three-dimensional perspective, in accordance with some embodiments. FIG. 9B illustrates a two-dimensional projection 920 of the tree 910 in FIG. 9A, in accordance with some embodiments. In some embodiments, the tree 910 includes nodes 914 that may be connected by connectors 912 (e.g., branches). Each of the nodes 914 represents a respective cell population (e.g., cell type). The size of the node 914 is proportional to the cell population. In some embodiments, the tree 910 of cell populations is constructed by ranking the cells based on their frequency of occurrence in a respective block (or a respective tissue slice), as determined by the impedance profiles. The tree 910 of cell populations visually depicts cell types with high-occurring frequencies, followed by sub-populations of cells that occur less frequently than the highly-occurring cells, followed by further sub-branches of high frequency of lower amplitude impedance scores.

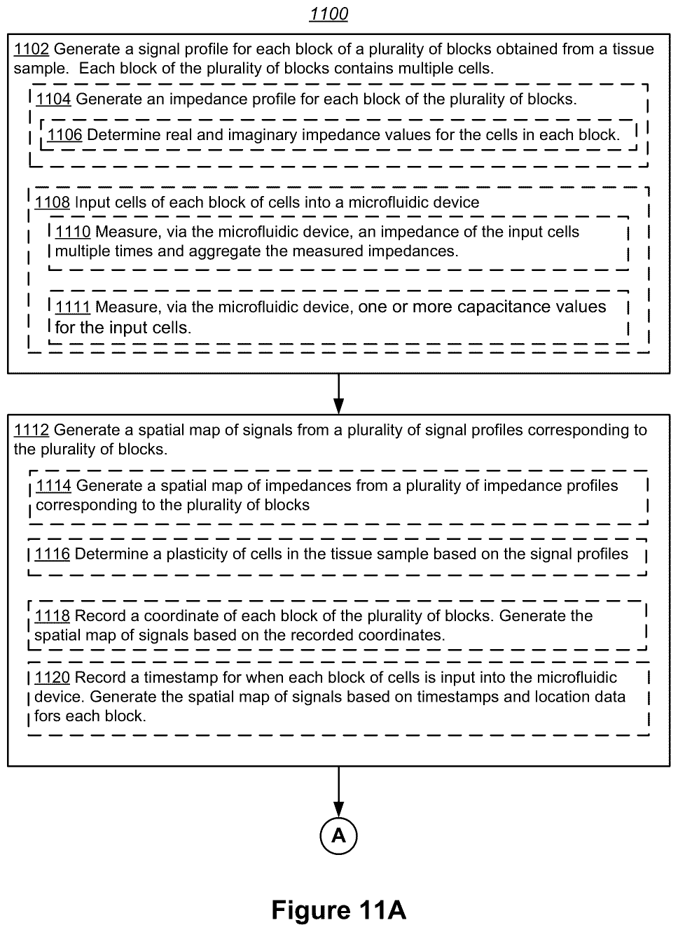

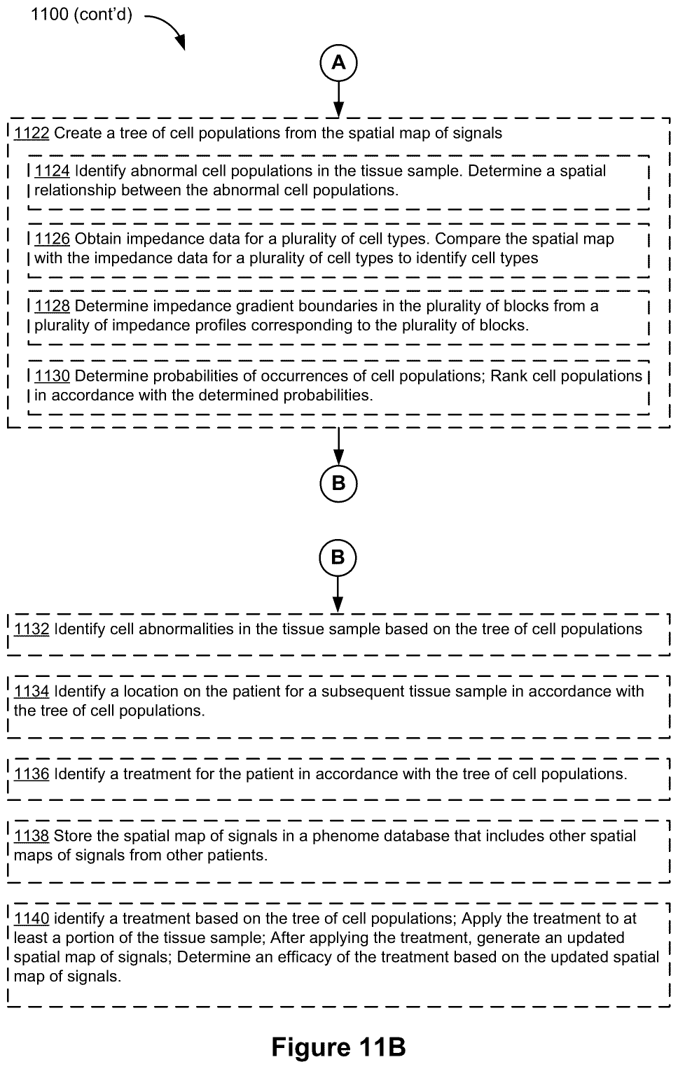

In some embodiments, a score is computed for a respective block of cells by determining the distribution of cells for each type in the respective block, and calculating the mean and standard deviations for each distribution. An exemplary score representation is the mean of the distribution. An example of the calculation is the Shannon Index (described below with respect to FIG. 11).

The tree 910 (and its projection 920) show the relationship of the different cell populations (e.g., how cell type A is connected to cell type B, B to C, C to D, etc.). The x-axis in FIGS. 9A and 9B denote a number of times the blocks were processed by the microfluidic device 100. In some instances, the relationship of the different cell populations is more clearly elucidated as the number of runs increases.

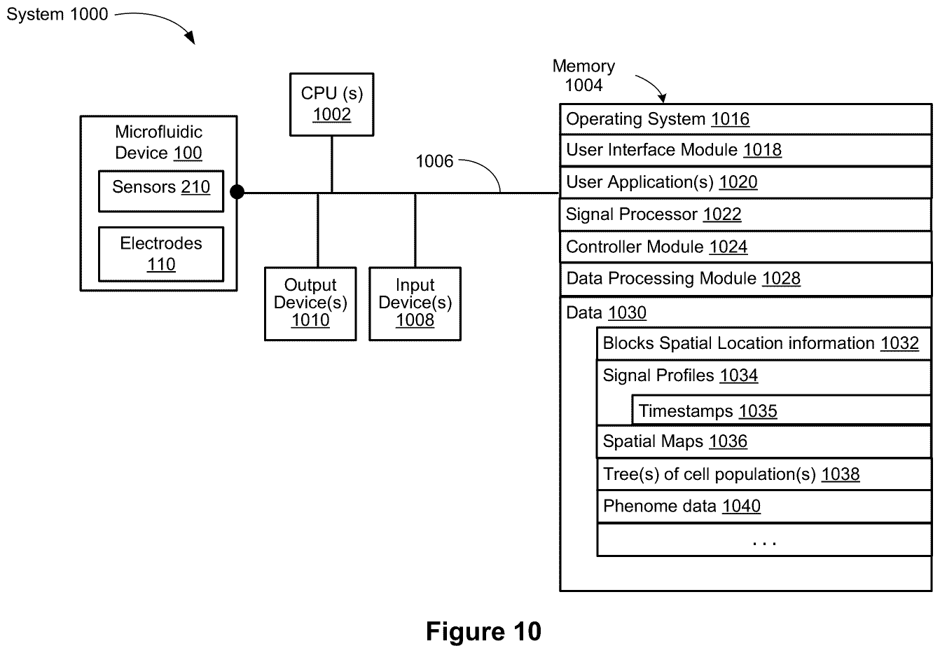

FIG. 10 is a block diagram of a system 1000 configured to perform single cell phenotype analysis, in accordance with some embodiments. The system 1000 typically includes one or more processors (e.g., processing units or CPUs) 1002, memory 1004, and one or more communication buses 1006 for interconnecting these components (sometimes called a chipset). In some embodiments, the system 1000 is communicatively connected to a microfluidic device (e.g., device 100). In some embodiments, the system 1000 is communicatively connected to the one or more components of the device 100, such as the piezoelectric actuators 109, the sensors 210 and/or the one or more electrode pairs 110, and is configured to select parameters for controlling the sensors 210 and/or electrode pairs 110.

In some embodiments, the system 1000 includes one or more input devices 1008 that facilitate user input, such as a keyboard, a mouse, a voice-command input unit or microphone, a touch screen display, a touch-sensitive input pad, a gesture capturing camera, or other input buttons or controls. In some embodiments, the system 1000 includes one or more cameras or scanners for capturing data. The system 1000 also includes one or more output devices 1010 that enable presentation of user interfaces and display content, including one or more speakers and/or one or more visual displays. For example, in some embodiments, the system is configured to display (or cause to display) signal profile(s) 502, histogram(s) 602 of cell populations, spatial map(s) 802 depicting how cells are distributed across tissue sample(s), and/or tree(s) 910 of cell populations.

In some implementations, the memory 1004 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. In some implementations, the memory 1004 includes one or more storage devices remotely located from one or more processing units 1002. The memory 1004, or alternatively the non-volatile memory device(s) within the memory 1004, includes a non-transitory computer-readable storage medium. In some implementations, the memory 1004 or the computer-readable storage medium of the memory 1004 stores the following programs, modules, and data structures, or a subset or superset thereof:
Operating system 1016 including procedures for handling various basic system services and for performing hardware dependent tasks;
User interface module 1018 for enabling presentation of information (e.g., a graphical user interface for application(s) 1020, widgets, websites and web pages thereof, and/or games, audio and/or video content, text, etc.) at the system 1000 via one or more output devices 1010 (e.g., displays, speakers, etc.);
One or more user applications 1020 for execution by the system 1000 (e.g., web or non-web based applications for controlling another electronic device, or for reviewing data captured by such devices);
Signal processor 1022 for signals (e.g., impedance or current) captured by the one or more sensors 210;
Controller module 1024 for selecting parameters for controlling the sensors 210 and/or pairs of electrodes 110.
Data processing module 1028 for recording and processing content data, generating signal profiles 502, histogram 602, spatial maps 802, and/or trees of cell populations (e.g., trees 910 and their 2D projections 920); and
Data 1030, including:
   spatial location information 1032 of blocks of respective tissue samples;
   signal profiles 1034 including timestamps 1035;
   Spatial maps 1036;
   Tree(s) of cell population(s) 1038; and
   Phenome data 1040 (e.g., a database) from different patients.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 1004 optionally stores a subset of the modules and data structures identified above. Furthermore memory 1004 is configured to store additional modules and data structures not described above.

In some embodiments, the memory 1004 (e.g., the programs, modules, and data structures stored thereon) includes instructions that are programmed to perform the operations described with respect to FIGS. 1 to 9B, 11A, and 11B.

In some embodiments, the memory is 1004 is configured to execute the instructions automatically (e.g., without user intervention). In some implementations, the memory is 1004 is configured to execute the instructions in accordance with (e.g., in response to) user interactions that are received via the one or more input devices 1008.

FIGS. 11A and 11B illustrate a flowchart diagram for a method 1100 of generating signal maps, in accordance with some embodiments. In some embodiments, the method 1100 is performed at a system (e.g., system 1000) that includes one or more processors (e.g., CPU(s) 1002) and memory (e.g., memory 1004). The memory stores instructions that are configured for execution by the one or more processors. In some embodiments, the system 1000 is a computer system (e.g., a server, a standalone computer, a workstation, a smart phone, a tablet device, a medical system) that is in communication with a microfluidics device (e.g., device 100). In some embodiments, the system 1000 is a microfluidics device.

The method includes generating (1102) a signal profile (e.g., signal profile 502, impedance profile, or current profile) for each block (e.g., block of cells) (e.g., block 304) of a plurality of blocks (e.g., block 304-1 and 304-2) obtained from a tissue sample.

In some embodiments, the tissue sample has an area in the range of 5 mm² to 500 mm².

In some embodiments, the plurality of blocks are obtained from the tissue sample by separating the tissue sample into a plurality of layers (e.g., slices) and dividing each layer of the plurality of layers into a separate plurality of blocks. For example, each layer has a thickness in the range of 0.5 mm to 10 mm.

In some embodiments, the plurality of blocks comprises a grid of blocks. In some embodiments, dividing the tissue sample into a plurality of blocks includes dividing the tissue sample into a two-dimensional matrix (e.g., a grid) of m rows by n columns, wherein the plurality of blocks is m x n (e.g., as illustrated in FIG. 3).

In some embodiments, each block of the plurality of blocks has a length and/or width in the range of 0.5 mm to 10 mm. In some embodiments, each block of the plurality of blocks has the same size. For example, in some embodiments, each block has an area in the range of about 1 mm² to 5 mm². In some embodiments, each block of the plurality of blocks has a size that is selected based on a desired signal-to-noise ratio (e.g., of a signal profile 502).

In some embodiments, the signal profile for each block is generated using a transimpedance amplifier (e.g., transimpedance amplifier 212).

With continued reference to FIG. 11A, in some embodiments, generating the signal profile for each block of the plurality of blocks comprises generating (1104) an impedance profile for each block of the plurality of blocks. In some embodiments, the impedance profile is a time-series plot showing impedance values of cells in a respective block over time, as individual cells of each block pass through a microfluidic flow channel (e.g., channel 102) of a microfluidic device. For example, in FIG. 5, each data mark (e.g., data point) 504 on the signal profile 502 (e.g., impedance profile) corresponds to a respective impedance value of one cell (e.g., a single cell) as the cell passes under the electrodes of a microfluidics chip.

In some embodiments, generating the impedance profile for each block includes determining (1106) real and imaginary impedance values for the cells (e.g., for each of the cells) in each block of the plurality of blocks.

In some embodiments, the impedance profile for each block is generated label-free, i.e., without applying any markers (such as optical or magnetic markers) to the cells in the plurality of blocks.

In some embodiments, generating the signal profile for each block of the plurality of blocks includes inputting (1108) cells of each block of cells into a microfluidic device (e.g., device 100).

For example, in some embodiments, the cells of each block (e.g., a solid block) are dissociated from the block to form a cell suspension in a liquid medium, which is then input into an inlet (e.g., inlet port 106) of the microfluidic device.

In some embodiments, prior to inputting the cells of each block into the microfluidic device, a baseline of “ground truth” is established by inputting, into the microfluidic device, cells of known cell line(s), to obtain an impedance profile for the known cell line(s).

In some embodiments, prior to inputting the cells of each block into the microfluidic device, a baseline of “noise floor” is established by inputting, into the microfluidic device, buffer solution(s) that are used to create the liquid suspension of cells, to obtain a baseline profile of the buffer solution(s).

In some embodiments, the signal profile (e.g., impedance profile) for a respective block includes a series of peaks (e.g., data marks 504 or data points in FIG. 5). Each of the peaks corresponds to an impedance value of a single cell. In some embodiments, the cell type corresponding to a respective peak is identified by mapping the impedance value to a value of known cell type (within a threshold number, percentage, etc.)

In some embodiments, the signal profile for each block of the plurality of blocks comprises an impedance profile. Generating the signal profile for each block of the plurality of blocks includes measuring (1110), via the microfluidic device 100, an impedance of the input cells multiple times and aggregating (e.g., summing or averaging) the measured impedances. For example, in some embodiments, the method includes repeating the impedance measurements for the same block of cells or by subjecting the same block to multiple runs on the microfluidic device 100.

In some embodiments, generating the signal profile for each block of the plurality of blocks includes measuring (1111), via the microfluidic device, one or more capacitance values for the input cells.

The method includes generating (1112) a spatial map of signals (e.g., spatial map 802) from a plurality of signal profiles corresponding to the plurality of blocks (e.g., by concatenating, combining, or aggregating respective signal profiles of the grid of blocks).

In some embodiments, generating the spatial map of signals from the plurality of signal profiles includes generating (1114) a spatial map of impedances from a plurality of impedance profiles corresponding to the plurality of blocks.

In some embodiments, the method includes determining (1116) a plasticity of cells in the tissue sample based on the signal profiles. For example, the Shannon Index (also known as the Shannon Diversity Index or the Shannon-Wiener Index) is a way to measure the diversity of cells in a population of cells. In some embodiments, the method includes calculating a Shannon Index for the cells in the tissue sample (e.g., for a respective block of cells or for a respective tissue slice to determine the entropy/probabilities of occurrences of the sub-population of the single cell plasticity. The Shannon Index is defined as:

$$\\ \begin{matrix}{H}^{{}_{} ′} = - {\sum }_{i = 1}^{k} {p}_{i} log {p}_{i} & ( 1 )\end{matrix}$$

In Equation (1), pᵢ is the probability (or proportional abundance) of the i^{th} type of cells. A higher probability means a higher frequency of high impedance values and a lower probability means a low frequency of lower amplitude impedance values.

In some embodiments, the method includes recording (1118) a coordinate of each block of the plurality of blocks, wherein the spatial map of signals is generated based on the recorded coordinates.

In some embodiments, the method includes recording (1120) a timestamp for when each block of cells is input into the microfluidic device, wherein the spatial map of signals from the plurality of signal profiles corresponding to the plurality of blocks is generated based on the timestamps and location data for each block (e.g., position data of a respective block relative to other blocks).

In some embodiments, the method includes creating (1122) a tree of cell populations (e.g., tree 910) from the spatial map of signals.

In some embodiments, creating the tree of cell populations from the spatial map of signals includes identifying (1124) abnormal cell populations (e.g., cell types) in the tissue sample; and determining a spatial relationship (e.g., branches) between the abnormal cell populations.

In some embodiments, creating the tree of cell populations from the spatial map of signals includes obtaining (1126) impedance data for a plurality of cell types. Creating the tree of cell populations from the spatial map of signals comprises comparing the spatial map with the impedance data to identify cell types.

In some embodiments, the plurality of cell types includes a plurality of diseased cell types.

In some embodiments, the signal profile for each block comprises an impedance profile. The method includes determining (1128) a histogram of impedance gradient boundaries in the plurality of blocks from a plurality of impedance profiles corresponding to the plurality of blocks, and creating the tree of cell populations based on the histogram of impedance gradient boundaries.

In some embodiments, creating the tree of cell populations includes determining (1130) probabilities of occurrences of cell populations; and ranking cell populations in accordance with the determined probabilities.

With continued reference to FIG. 11B, in some embodiments, the method includes identifying (1132) cell abnormalities in the tissue sample based on the tree of cell populations.

In some embodiments, the tissue sample is from a patient. The method includes identifying (1134) a location on the patient for a subsequent tissue sample in accordance with the tree of cell populations.

In some embodiments, the tissue sample is from a patient. The method includes identifying (1136) a treatment for the patient in accordance with the tree of cell populations.

In some embodiments, the tissue sample is from a patient. The method includes storing (1138) the spatial map of signals in a phenome database (e.g., phenome data 1040) that includes other spatial maps of signals from other patients. For example, in some embodiments, each of the entries in the phenome database corresponds to a respective patient, and includes a respective spatial map of impedance (e.g., including impedance values (real and imaginary components)), spatial location cell types, and a respective signaling rate matrix. Signaling rate is calculated as product of the probability of occurrence of a cell type and its spatial location. The respective signaling rate matrix is a collection of such measurements. In some embodiments, the phenome database is cross referenced across with the Genome tree. In some embodiments, the phenome database is applied to develop personalized medicine.

In some embodiments, the method includes identifying (1140) a treatment based on the tree of cell populations; applying the treatment to at least a portion of the tissue sample; after applying the treatment, generating an updated spatial map of signals; and determining an efficacy of the treatment based on the updated spatial map of signals.

In some embodiments, if the blocks of cells are dissociated in an appropriate buffer solution, the cells continue to grow in the buffer. Thus, in some embodiments, the method includes generating an updated impedance profile each block of the plurality of blocks of cells after a predefined time interval (e.g., after 1 day, 3 days, 5 days, or 7 days), and generating an updated spatial map of signals from a plurality of updated impedance profiles corresponding to the plurality of blocks to determine whether the characteristics of cells change over time, or how a certain disease is progressing.

The microfluidic devices described herein allow for electrical and/or optical sensing of one or more cells (or other particles). The microfluidic aspect of the devices allows for precise flow control (e.g., using electrodes, MEMS sensors, and/or piezoelectric components). Additionally, the piezoelectric layer allows for additional integrated functions such as cell sorting (e.g., after the cell signatures are captured). In some embodiments where the substrate is composed of silicon (e.g., the second substrate portion), the electrodes are deposited (e.g., in various aspect ratios) in proximity to one another (e.g., allowing handling various sample types and sample heterogeneity). The piezoelectric component (e.g., a MEMS piezoelectric layer) having an outlet port (e.g., a nozzle) allows direct ejection (e.g., jetting) of cells (e.g., after they have been processed).

Some embodiments may be described with respect to the following clauses:

Clause 1. A method of generating signal map, comprising: generating a signal profile for each block of a plurality of blocks obtained from a tissue sample, wherein each block of the plurality of blocks contains multiple cells; and generating a spatial map of signals from a plurality of signal profiles corresponding to the plurality of blocks.

Clause 2. The method of clause 1, wherein generating the signal profile for each block of the plurality of blocks comprises generating an impedance profile for each block of the plurality of blocks.

Clause 3. The method of clause 2, wherein generating the spatial map of signals from the plurality of signal profiles includes generating a spatial map of impedances from a plurality of impedance profiles corresponding to the plurality of blocks.

Clause 4. The method of clause 2 or clause 3, wherein generating the impedance profile for each block includes determining real and imaginary impedance values for the cells in each block of the plurality of blocks.

Clause 5. The method of any of clauses 2-4, wherein the impedance profile for each block is generated without applying optical or magnetic markers to the cells in the plurality of blocks.

Clause 6. The method of any of clauses 1-5, further comprising: creating a tree of cell populations based on scores of occurrences from the spatial map of signals.

Clause 7. The method of clause 6, wherein creating the tree of cell populations from the spatial map of signals comprises: identifying abnormal cell populations in the tissue sample; and determining a spatial relationship between the abnormal cell populations.

Clause 8. The method of clause 6 or clause 7, further comprising: obtaining signal data for a plurality of cell types, wherein creating the tree of cell populations based on scores of occurrences from the spatial map of signals comprises comparing the spatial map with the signal data to identify cell types.

Clause 9. The method of clause 8, wherein the plurality of cell types includes a plurality of diseased cell types.

Clause 10. The method of any of clauses 6-9, wherein: the signal profile for each block comprises an impedance profile; and the method includes: determining a histogram of impedance gradient boundaries in the plurality of blocks from a plurality of impedance profiles corresponding to the plurality of blocks, wherein the tree of cell populations is created based on the histogram of impedance gradient boundaries.

Clause 11. The method of any of clauses 6-10, wherein creating the tree of cell populations comprises: determining probabilities of occurrences of cell populations; and ranking cell populations in accordance with the determined probabilities.

Clause 12. The method of any of clauses 6-11, further comprising identifying cell abnormalities in the tissue sample based on the tree of cell populations.

Clause 13. The method of any of clauses 6-12, wherein: the tissue sample is from a patient; and the method further includes identifying a location on the patient for a subsequent tissue sample in accordance with the tree of cell populations.

Clause 14. The method of any of clauses 6-13, wherein: the tissue sample is from a patient; and the method further includes identifying a treatment for the patient in accordance with the tree of cell populations.

Clause 15. The method of any of clauses 6-14, wherein: the tissue sample is from a patient; and the method further includes storing the spatial map of signals in a phenome database that includes other spatial maps of signals from other patients.

Clause 16. The method of any of clauses 6-15, further comprising: identifying a treatment based on the tree of cell populations; applying the treatment to at least a portion of the tissue sample; after applying the treatment, generating an updated spatial map of signals; and determining an efficacy of the treatment based on the updated spatial map of signals.

Clause 17. The method of any of clauses 1-16, further comprising determining a plasticity of cells in the tissue sample based on the signal profiles.

Clause 18. The method of any of clauses 1-17, wherein the plurality of blocks comprises a grid of blocks.

Clause 19. The method of any of clauses 1-18, wherein the plurality of blocks are obtained from the tissue sample by: separating the tissue sample into a plurality of layers; and dividing each layer of the plurality of layers into a separate plurality of blocks.

Clause 20. The method of clause 19, wherein each layer has a thickness in the range of 0.5 mm to 10 mm.

Clause 21. The method of any of clauses 1-20, wherein each block of the plurality of blocks has the same size.

Clause 22. The method of any of clauses 1-21, further comprising recording a coordinate of each block of the plurality of blocks, wherein the spatial map of signals is generated based on the recorded coordinates.

Clause 23. The method of any of clauses 1-22, wherein generating the signal profile for each block of the plurality of blocks comprises inputting cells of each block of cells into a microfluidic device.

Clause 24. The method of clause 23, wherein the microfluidic device comprises a microfluidic sensor chip.

Clause 25. The method of clause 23 or clause 24, wherein the microfluidic device comprises one or more electromagnetic field generators configured to apply a preset frequency to the input cells.

Clause 26. The method of clause 25, wherein the microfluidic device is configured to measure an impedance of the input cells in response to the preset frequency.

Clause 27. The method of clause 25 or clause 26, wherein the preset frequency corresponds to a particular type of cell abnormality.

Clause 28. The method of any of clauses 25-27, wherein the preset frequency is in the range of 1 kHz to 10 GHz.

Clause 29. The method of any of clauses 25-28, wherein the preset frequency is applied to the input cells using one or more electrodes.

Clause 30. The method of any of clauses 23-29, wherein: the signal profile for each block of the plurality of blocks comprises an impedance profile; and generating the signal profile for each block of the plurality of blocks includes measuring an impedance of the input cells multiple times and aggregating the measured impedances.

Clause 31. The method of clause 30, wherein each measurement of impedance of the input cells is performed with a different set of parameters.

Clause 32. The method of clause 31, wherein the set of parameters include an applied frequency, a flow rate, and a sample fluid mixture.

Clause 33. The method of any of clauses 23-32, wherein each input cell is processed through the microfluidic device in a time range of 0.5 seconds to 10 seconds.

Clause 34. The method of any of clauses 23-33, wherein generating the signal profile for each block of the plurality of blocks includes measuring one or more capacitance values for the input cells.

Clause 35. The method of any of clauses 23-34, wherein each block of cells is input into the microfluidic device sequentially.

Clause 36. The method of clauses 23-35, further comprising: recording a timestamp for when each block of cells is input into the microfluidic device, wherein the spatial map of signals from the plurality of signal profiles corresponding to the plurality of blocks is generated based on the timestamps and location data for each block.

Clause 37. The method of any of clauses 1-36, wherein each block of the plurality of blocks has a length and/or width in the range of 0.5 mm to 10 mm.

Clause 38. The method of any of clauses 1-37, wherein the signal profile for each block is generated using a transimpedance amplifier.

Clause 39. The method of any of clauses 1-38, wherein the tissue sample has an area in the range of 5 mm² to 500 mm².

Clause 40. The method of any of clauses 1-39, wherein each block of the plurality of blocks has a size that is selected based on a desired signal to noise ratio of the signal profile.

Clause 41. A system, comprising: one or more processors; and memory storing instructions that, when executed by the one or more processors, cause the system to perform the method of any of clauses 1-40.

Clause 42. The system of clause 41, further comprising: a microfluidic device configured to detect impedance of cells; and the memory includes instructions that, when executed by the one or more processors, cause the system to: generate an impedance profile for each block of the plurality of blocks based on detected impedances from the microfluidic device.

Clause 43. The system of clause 42, wherein the microfluidic device comprises: a substrate with a microfluidic channel having at least one outlet; and an array of piezoelectric actuators located adjacent to the at least one outlet for ejecting a portion of a fluid in the microfluidic channel.

Clause 44. The system of clause 42 or clause 43, wherein the microfluidic device comprises one or more sensors located adjacent to a first region of a microfluidic channel for sensing respective particles flowing through the microfluidic channel.

Clause 45. The system of any of clauses 42-44, wherein the microfluidic device comprises a first piezoelectric actuator located adjacent to a second region of a microfluidic channel downstream from the first region for deflecting the respective particles flowing through the microfluidic channel to respective output channels of the two or more output channels based on signals from the one or more sensors.

Clause 46. A non-transitory computer-readable storage medium having stored thereon program code instructions that, when executed by a processor, cause the processor to perform the method of any of clauses 1-40.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A system for generating a signal map, comprising:
memory;
one or more processors; and
a plurality of instructions and data stored in the memory and configured for execution by the one or more processors, the plurality of instructions including instructions for:
generating a signal profile for each block of a plurality of blocks obtained from a tissue sample, wherein each block of the plurality of blocks contains multiple cells; and
generating a spatial map of signals from a plurality of signal profiles corresponding to the plurality of blocks.

2. The system of claim 1, wherein the instructions for generating the signal profile for each block of the plurality of blocks include instructions for:
generating an impedance profile for each block of the plurality of blocks.

3. The system of claim 1, wherein the plurality of instructions further includes instructions for:
creating a tree of cell populations based on scores of occurrences from the spatial map.

4. The system of claim 3, wherein the instructions for creating the tree of cell populations further include instructions for:
identifying abnormal cell populations in the tissue sample; and
determining a spatial relationship between the abnormal cell populations.

5. The system of claim 3, wherein the plurality of instructions further includes instructions for:
obtaining signal data for a plurality of cell types, wherein the instructions for creating the tree of cell populations based on scores of occurrences from the spatial map comprises instructions for comparing the spatial map with the signal data to identify cell types.

6. The system of claim 3, wherein the signal profile for each block comprises an impedance profile, and the plurality of instructions further includes instructions for:
determining a histogram of impedance gradient boundaries in the plurality of blocks from a plurality of impedance profiles corresponding to the plurality of blocks, wherein the tree of cell populations is created based on the histogram of impedance gradient boundaries.

7. The system of claim 3, wherein the instructions for creating the tree of cell populations include instructions for:
determining probabilities of occurrences of cell populations; and
ranking cell populations in accordance with the determined probabilities.

8. The system of claim 1, wherein the plurality of instructions further includes instructions for:
recording a coordinate of each block of the plurality of blocks, wherein the spatial map of signals is generated based on a plurality of recorded coordinates corresponding to the plurality of blocks.

9. The system of claim 1, wherein the instructions for generating the signal profile for each block comprises instructions for inputting respective multiple cells of each block into a microfluidic device.

10. The system of claim 9, wherein the microfluidic device comprises a microfluidic sensor chip.

11. The system of claim 9, wherein the microfluidic device comprises one or more electromagnetic field generators configured to apply a preset frequency to the respective multiple cells of each block inputted into the microfluidic device.

12. The system of claim 9, wherein the instructions for generating the signal profile for each block includes instructions for, for each block:
measuring an impedance of the respective multiple cells multiple times; and
aggregating a plurality of measured impedances.

13. The system of claim 12, wherein for each of the multiple times, the impedance of the respective multiple cells is measured with a different set of parameters.

14. The system of claim 13, wherein the different set of parameters include an applied frequency, a flow rate, and a sample fluid mixture.

15. The system of claim 9, wherein each input cell is processed through the microfluidic device in a time range of 0.5 seconds to 10 seconds.

16. The system of claim 2, further comprising:
a microfluidic device configured to detect impedance of cells,
wherein the signal profile for each block is an impedance profile generated based on detected impedances from the microfluidic device.

17. The system of claim 16, wherein the microfluidic device comprises:
a substrate with a microfluidic channel having at least one outlet; and
an array of piezoelectric actuators located adjacent to the at least one outlet for ejecting a portion of a fluid in the microfluidic channel.

18. A method of generating a signal map, comprising:
generating a signal profile for each block of a plurality of blocks obtained from a tissue sample, wherein each block of the plurality of blocks contains multiple cells; and
generating a spatial map of signals from a plurality of signal profiles corresponding to the plurality of blocks.

19. The method of claim 18, wherein generating the signal profile for each block of the plurality of blocks comprises:
generating an impedance profile for each block of the plurality of blocks.

20. A non-transitory computer-readable storage medium storing one or more programs, the one or more programs comprising instructions, which when executed by a system, cause the system to perform operations comprising:
generating a signal profile for each block of a plurality of blocks obtained from a tissue sample, wherein each block of the plurality of blocks contains multiple cells; and
generating a spatial map of signals from a plurality of signal profiles corresponding to the plurality of blocks.
